(19) United States
(12) Patent Application Publication
(10) Pub. No.: US 2007/0192823 A1
(43) Pub. Date: Aug. 16, 2007

(54) Policy administration and provisioning

(75) Inventors: Carl B. Andersen, Orem, UT (US); Carolyn B. McClain, Springville, UT (US)

Correspondence Address: SCHWEGMAN, LUNDBERG, WOESSNER & KLUTH, P.A., P.O. BOX 2938, MINNEAPOLIS, MN, 55402, US

(73) Assignee: Novell, Inc.

(21) Appl. No.: 11/350,430

(22) Filed: Feb. 9, 2006

(51) Int. Cl. H04L 9/00

(52) U.S. Cl. 726/1

(57) ABSTRACT

Techniques for administering and provisioning policies are provided. Policies are translated to an intermediate format and provisioned to heterogeneous devices in native formats of those devices. Administration and interfaces to define and update the policies may occur in the intermediate format or in the native formats. Policies may be combined across devices and published from one device to another device. Policies may also be associated and administered for policy enforcement points.

### FIELD

The invention relates generally to networking and more particularly to techniques for administering and provisioning policy over a network.

### BACKGROUND

Today's enterprise environment often includes a set of heterogeneous devices on which an enterprise's services, such as World-Wide Web (WWW) services, are hosted. A typical device deployment might include switches, proxy servers, application servers, and WWW (web) servers; all of which are capable of enforcing one or more flavors of access restriction and/or security policies. For web and application servers that are not policy aware, a policy-enabled proxy may be used as a front-end to the server and act as a guardian to the protected web services, which are associated with the server.

Policy management presents a complex set of interactions for administrators who are responsible for ensuring restrictive policies. For example, to configure and enable a corporate policy for access to a particular web service, the administrator is usually required to know the network configuration and the web-services deployment to the hosting device before determining where and how to craft the proper corporate policy. Furthermore, if access to a particular web service is to be handled differently when access is initiated from outside the corporate firewall, then the policy may have to be applied to multiple devices and defined slightly differently for each different device supported.

Consequently, in an effort to simplify the management of a corporate network, some enterprises choose to force all access to protected web services through a proxy-server implementation. While this approach may simplify how to define the policy portion of administration, it does not simply or does not alleviate the provisioning of policies to multiple and potentially disparate supported devices. Moreover, it does not address web services that may not work well with a proxy interposed between the target services and the end user.

Thus, with the diverse environment that has emerged within distributed networks, enterprises are in need of improved techniques for administering and provisioning policies to their services for that diverse environment.

### SUMMARY

In various embodiments, techniques for administering and provisioning policies are presented. More specifically, and in an embodiment, a method for administering policy across heterogeneous devices is provided. A set of policies is defined in an intermediate language for a first device and a second device. The first and second devices are heterogeneous devices from one another. The set of policies is translated in a first format from the intermediate language for enforcement on first device and translated in a second format for enforcement on the second device.

### BRIEF DESCRIPTION OF THE DRAWINGS

FIG. 1 is a diagram of a method for administering policies across heterogeneous devices, according to an example embodiment.

FIG. 2 is a diagram of method for combining policies from multiple policy enforcement points (PEP's), according to an example embodiment.

FIG. 3 is a diagram of a method for publishing policies from one device and enforcing the policies on another heterogeneous device, according to an example embodiment.

FIG. 4 is a diagram of a policy administration and provisioning system, according to an example embodiment.

### DETAILED DESCRIPTION

A “resource” includes a user, content, a device, a node, a service, a system, a directory, a data store, groups of users, combinations of these things, etc. A resource may also be associated with an identity to uniquely distinguish a particular resource from another resource that may be active on a network. A device (type of resource) is heterogeneous from another device when one device has a different configuration, utilizes different resources, utilizes different versions of the same resources, and/or has different hardware or software from another device.

A “policy” is one or more rules, one or more actions, one or more conditions, one or more events, and/or one or more attributes applied to and associated with a resource or a set of resources. Policies may be grouped into sets of policies and applied to individual resources or applied to multiple and selective groupings of resources. Thus, a policy may logically be viewed as a named set of rules, where the rules can include a variety of conditions, actions, events, and/or attributes.

A “policy enforcement point” (PEP) is a point or location within an application's processing logic where the logic calls another module to assist in providing some functionality regarding policy evaluation. A PEP for an application is usually implemented using embedded Application Programming Interface (API) calls, where the API calls are related to the module that is providing the policy evaluation.

Various embodiments of this invention can be implemented in existing network architectures. For example, in some embodiments, the techniques presented herein are implemented in whole or in part in the Novell® network and proxy server products, email products, identity management products, access management products, operating system products, and/or directory services products distributed by Novell®, Inc., of Provo, Utah.

Of course, the embodiments of the invention can be implemented in a variety of architectural platforms, operating and server systems, or applications. Any particular architectural layout or implementation presented herein is provided for purposes of illustration and comprehension only and is not intended to limit aspects of the invention.

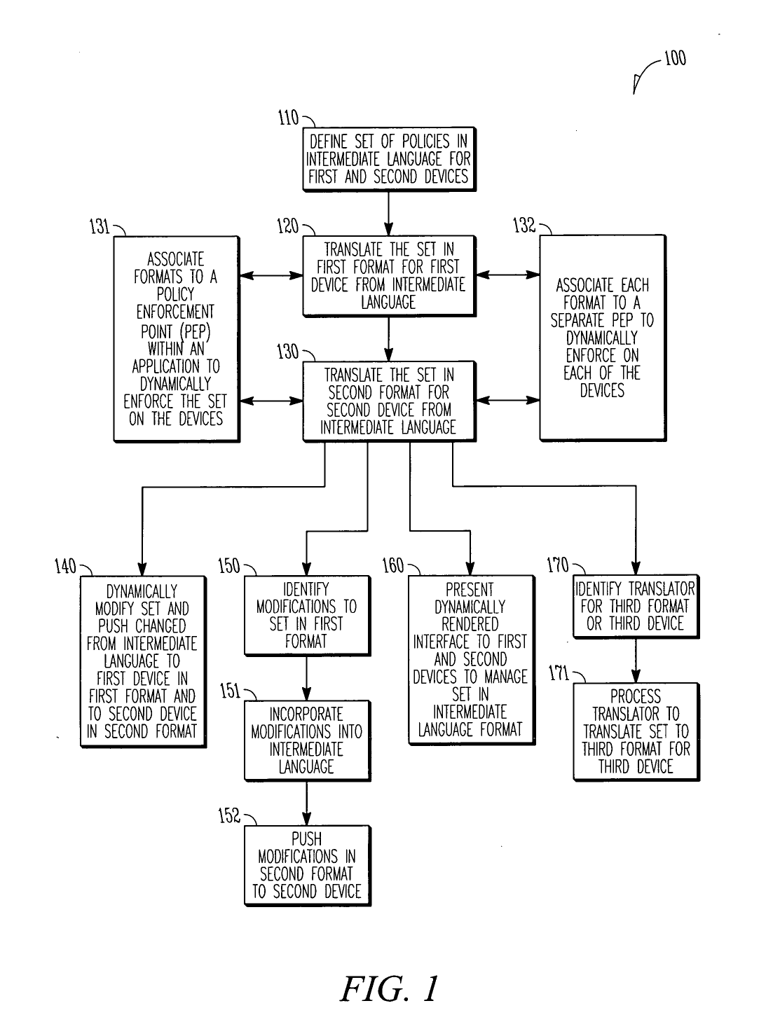

FIG. 1 is a diagram of a method 100 for administering policies across heterogeneous devices, according to an example embodiment. The method 100 (hereinafter “policy provisioning service”) is implemented in a machine-accessible and readable medium. The policy provisioning service is operational over and processes within a network. The network may be wired, wireless, or a combination of wired and wireless.

Initially, an intermediate policy markup language is provided for purposes of expressing policies. According, to an embodiment the intermediate policy markup language is enabled or represented as a subset of extensible markup language (XML) and may be referred to as extensible policy expression markup language (XPEML). XPEML may be represented as a set of XML schema elements defining policy definitions and expressions, which include rules, conditions, actions, etc. According to an embodiment, the XPEML is based on the Policy Core Information Model presented in the Internet Engineering Task Force (IETF) Groups' Request for Comments (RFC) number 3060. It is however to be understood that any intermediate markup language may be used for purposes of representing and expressing policy in a normalized and portable manner.

The policy provisioning service may be implemented within a proxy server or any other node within the network. The policy provisioning service is responsible for provisioning policies to resources of the network via an intermediate policy markup language.

With this context the processing of the policy provisioning service is now discussed with reference to FIG. 1. At 110, the policy provisioning service is used to define or to facilitate a definition of a set of policies in an intermediate policy markup language (IPML) for first and second devices. That is, the policy provisioning service may automatically assemble definitions for the set of policies or may present interfaces to other resources, such as administrators, to define the set of policies and to identify the first and second device for which the set of policies are to be applied to.

At 120, the policy provisioning service translates the set in a first format for the first device from the IPML. It may be the case that one or more translators are used to translate the set of policies from the IPML into a format that is recognized by and capable of being processed on the first device.

At 130, the policy provisioning service also translates the set of policies in a second format for the second device from the IPML. So, other translators associated with the IPML may be attached to the set of policies and processed for purposes of translating the set from the IPML into a second format that is recognized and capable of being processed on the second device.

According to an embodiment, at 131, the first and second formats may be mapped, linked, or associated with a PEP within an application that the two devices use for dynamically enforcing policies. Thus, a common PEP for an application may be used to enforce policies on both devices. The policy provisioning service may associate the first and second formats of the set of policies to this common PEP to ensure that the set of policies are properly enforced on the first and second devices within that common PEP. The common PEP may use the identity or some other attribute/identifier of the devices to detect which format is to be used with which device. That is, the first device recognizes the first format and the second device recognizes the second format; a common PEP may dynamically account for this by selecting the proper format at runtime based on the identities of the devices being handled at any particular processing point.

In another case, at 132, the first format associated with the first device may have a different PEP for policy enforcement than the second device. In such a case, the policy provisioning service may associate each format for the set of policies with its respective PEP. This may mean that the first device uses a first application and first PEP to enforce its policies while the second device uses a second application and a second PEP to enforce policies. In this situation, the policy provisioning service modifies each PEP to ensure the proper formats for the common set of policies are associated with the proper applications and devices.

In an embodiment, at 140, the policy provisioning service may be used to dynamically modify the set of policies and to push the changes from the IPML to the first device in the first format and to the second device in the second format. So, a common interface to the IPML may permit an administrator or some other automated service to modify the set of policies being enforced on the first and second devices. The policy provisioning service can recognize these changes and based on global policies associated with the policy provisioning service make decisions as to when the changes are to be dynamically pushed from the IPML to each of the devices in their native recognized policy formats.

Additionally it is noted that changes to the set of policies need not occur in the IPML format. For example, at 150, the policy provisioning service may detect modifications to the set of policies in the first format that is being enforced on the first device. Global policies or instructions to the policy provisioning service may dictate that the policy provisioning service, at 151, incorporate the modifications from the first format into the IPML and from there, at 152, the modifications may be synchronized and dynamically pushed in the second format natively recognized by the second device. The scenario presented at 150-152 may also occur for changes to the set of policies in the second format on the second device in a similar manner such that the changes are synchronized to the IPML and then dynamically pushed to the first device in its first format.

In yet another embodiment, at 160, the policy provisioning service may dynamically render separate interfaces to the first and second devices to permit the processing at 150-152 to occur. So, the format of the interface may be rendered to the first device in the first format and also rendered to the second device in the second format. The administrators or other automated services of these device may access the interfaces to make changes and the changes are noted by the policy provisioning service in the IPML and synchronized when it is appropriate to do so.

According to an embodiment, at 170, the policy provisioning service may also identify a translator for a third format or third device that is to be associated with the set of policies being enforced and provisioned to the first and second devices. Thus, at 171, the translator is processed against the set of policies in the IPML to produce the set of policies in the third format; and the set of policies in the third format may then be provisioned to the third device. This processing scenario may be repeated for any desired number of heterogeneous devices, such that a new format and device are integrated by associating and linking a new policy translator to the proper set of policies in the IPML.

It is now understood, how the policy provisioning service may be used to centrally distribute or provision policies to different and heterogeneous devices over a network. The policies are expressed in a common IPML and the policy provisioning service renders a desired set of policies to each device in that device's native recognized policy format. The administration of the policies may occur in the IPML or in the individual native recognized languages or formats of the separate heterogeneous devices. Furthermore, the enforcement point for each device may be recognized and communicated via a PEP; and that PEP may be the same across devices or different across devices.

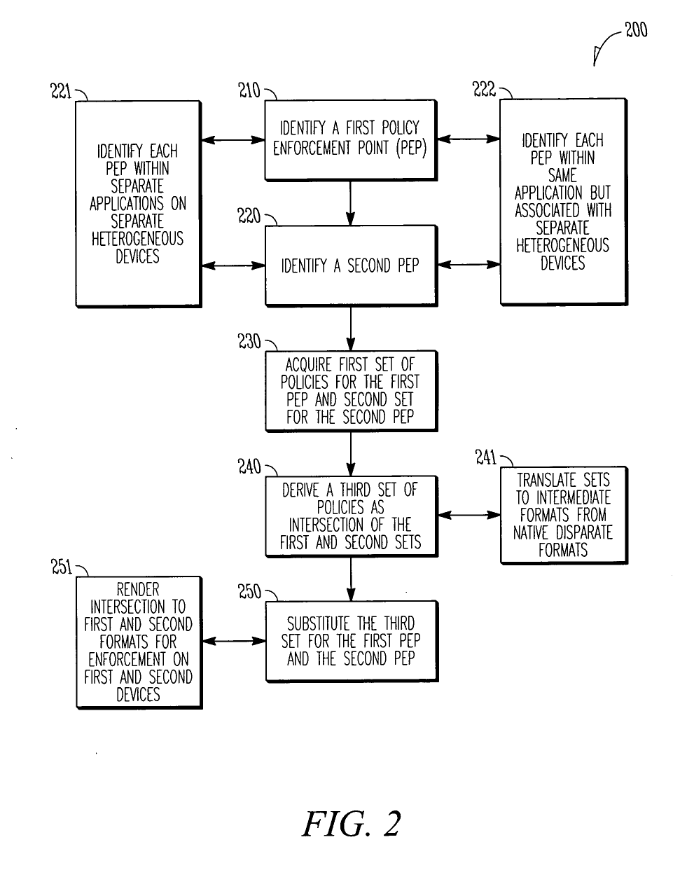

FIG. 2 is a diagram of method 200 for combining policies from multiple policy enforcement points (PEP's), according to an example embodiment. The method 200 (hereinafter “policy aggregating service” is implemented in a machine-accessible and readable medium and is operational over a network. The network may be wired, wireless, or a combination of wired and wireless. According to an embodiment, the policy aggregating service interacts with the policy provisioning service represented by the method 100. That is, the actual policies, which are enforced on the heterogeneous devices depicted with the policy provisioning service, may be enforced from a PEP and may use the policy aggregating service to assist in that policy integration and enforcement.

The policy aggregating service may be utilized as an enhancement or sub-service of the policy provisioning service represented by the method 100 of the FIG. 1. The policy aggregating service permits policies across multiple PEP's to be combined and enforced as an intersection within designated PEP's. Again, a single PEP may be associated with a single device or multiple devices. The PEP represents a processing point within an application where a call is made to an external policy service for policy enforcement or evaluation.

At 210, the policy aggregating service identifies a first PEP and, at 220, the policy aggregating service identifies a second PEP. The identification may be the result of a different policy that is being evaluated and that triggers the action of the policy aggregating service or the identification may occur via an interface at the direction of an administrator that has a desire to tie policies for multiple PEP's together as a single enforceable policy set.

According to an embodiment, at 221, the policy aggregating service may identify each PEP within a separate application on separate heterogeneous devices. That is, the first PEP may be associated with a first application and processing point or call within that first application where policy is evaluated for a first device and the second PEP may be associated with a second application and processing point or call within that second application where policy is evaluated for the second device.

In another situation, at 222, the policy aggregating service may identify each PEP as being within the same application but still associated with separate heterogeneous devices. That is, an application may process on multiple devices and depending upon where it is processing at any given point it uses a different set of instructions compatible with that particular device on which it is processing. In this case, it may be that a same application with different PEP's is being used from two different and heterogeneous devices. For such a scenario, the policy aggregating service may identify the different PEP's within the same enforcing application for both the different devices.

At 230, the policy aggregating service acquires a first set of policies for the first PEP and acquires a second set of policies for the second PEP. These policies may exist in an IPML or may exist in the native formats recognized by the proper devices. In cases, where the two sets are not in the IPML, the policy aggregating service may translate the native formats of the sets into the IPML in manners similar to what was discussed and presented above with respect to the policy provisioning service represented by the method 100 of the FIG. 1.

Once the first and second set of policies are acquired for each of the different PEP's and are translated into a IPML, if they were not already acquired in the IPML, at 240, the policy aggregating service derives a third set of policies. In an embodiment, the third set of policies may be derived as an intersection of the first and second sets of policies. So, the policies of the first set that intersect or overlap the policies of the second set are retained as a newly defined third set of policies. It is noted that the intersection does not have to always be used as the third set of policies; in fact, any set operation may be performed or other algorithmic calculation to derive the third set of policies from the first and second sets of policies.

In an embodiment, at 241, the policy aggregating service may, as was discussed above, translate the sets into the IPML from their individual native policy data formats before the two sets are evaluated together and the third set is derived. Again, this does not have to occur when the first and second sets are already in and acquired in the IPML.

At 250, the newly acquired third set of policies is substituted within the first and second PEP's for subsequent enforcement. So, the new third set of policies is rendered, at 251, as an intersection of the first and second formats and dynamically enforced on the first and second devices by translating the third set into the proper formats recognized by the devices and linking the third set to the first and second PEP's.

It is now appreciated how multiple sets of policies for multiple PEP's may be identified in an automated fashion and combined into a new set. The new set may be dynamically rendered and configured into the proper PEP's and enforced for multiple disparate and heterogeneous devices.

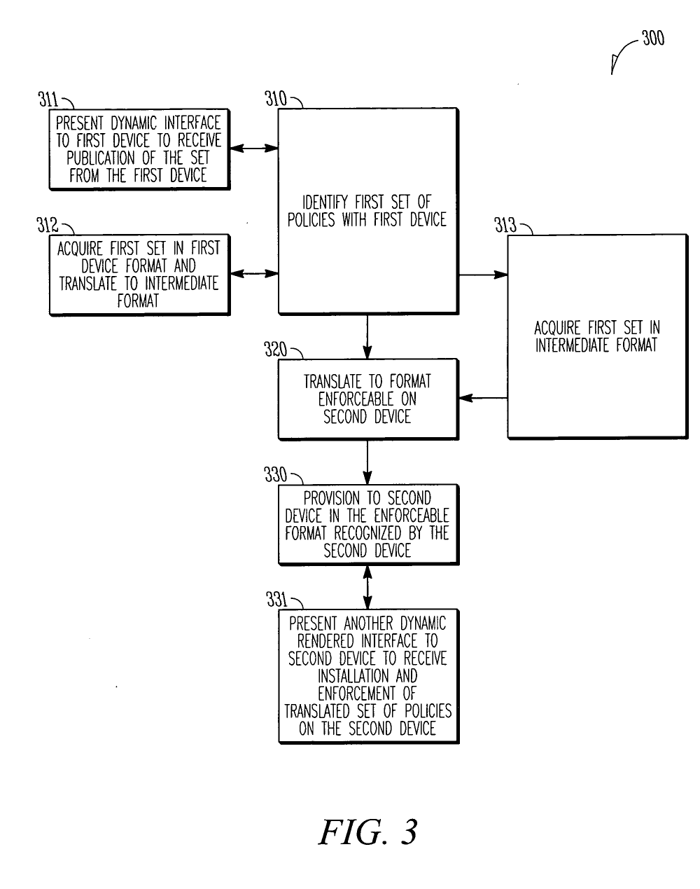

FIG. 3 is a diagram of a method 300 for publishing policies from one device and enforcing the policies on another heterogeneous device, according to an example embodiment. The method 300 (hereinafter “policy publishing service” is implemented in a machine-accessible and readable medium and is operational over a network. The network may be wired, wireless, or a combination of wired and wireless. In an embodiment, the policy publishing service represents another complimentary service to the policy provisioning service and to the policy aggregating service represented by the methods 100 and 200 of the FIGS. 1 and 2, respectively. That is, the policy publishing service provides techniques for policies of one device to be discovered and provisioned to other devices of the network for enforcement.

The policy provisioning service represented by the method 100 of the FIG. 1 presented techniques for enforcing policies across heterogeneous devices. The policy aggregating service represented by the method 200 of the FIG. 2 presented techniques for aggregating policies for multiple PEP's and dynamically enforcing on multiple heterogeneous devices. The policy publishing service presented here as the method 300 of the FIG. 3 describes how policies of one device may be discovered and used as a template or model for other disparate and heterogeneous devices of the network.

Accordingly, at 310, the policy publishing service identifies a first set of policies associated with a first device. The first set of policies may be discovered or identified in a variety of manners. For example, at 311, the policy publishing service may present a dynamic interface to the first device for purposes of receiving a publication of the first set of policies.

Other situations may exist as well. For example, mining services may mine the first device to discover or identify the first set of policies. In still other situations, the first set of policies may be housed and identified in an entirely separate data store, such that the policy publishing service performs a search or other technique against the data store to initially identify the first set of policies. So, the first set of policies may be discovered from the first device directly or indirection from sources outside and external to the first device.

According to an embodiment, at 312, the policy publishing service may initially acquire the first set of policies in a first device format and may translate from that first format to an IPML. Yet, in other cases, at 313, the policy publishing service may initially acquire the first set of policies in the IPML, such that no translation between formats is required at all.

It may also be the case, at 313 that the initially acquired set of policies for the first device is to be augmented in some manner. Thus, the set of policies may be modified or enhanced before they are rendered to other devices over the network.

At 320, the policy publishing service translates the first set of policies into a format that is enforceable on a second device. In an embodiment, the first and second devices are heterogeneous devices from one another. According to an embodiment, this may be achieved via a translator associated with entries within the IPML to convert the first set from the IPML to a second format that may be enforced on the second device. Examples of this were discussed above with respect to the policy provisioning service represented by the method 100 of the FIG. 1.

At 330, the policy publishing service provisions the set of policies in the second device's format to the second device for installation and enforcement on the second device. This may be achieved dynamically and in real time and without manual intervention or with some partial intervention using automated techniques as discussed below.

As an example of partial installation of the set of translated policies, consider, at 331, that the policy publishing service may present a dynamically rendered interface to the second device with the set of translated policies, such that an administrator or an automated service associated with the second device may install and load the set of translated policies for immediate enforcement on the second device. The interface may also be used to accept some aspects of the policies while other aspects are rejected. Or, the interface may be used to adjust or further modify the proposed policies that are to be enforced on the second device.

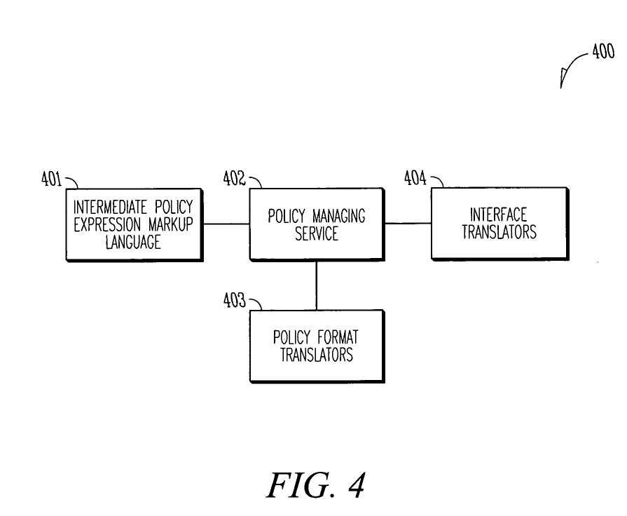

FIG. 4 is a diagram of a policy administration and provisioning system 400, according to an example embodiment. The policy administration and provisioning system 400 is implemented in a machine-accessible and readable medium and is accessed and processed over a network. The network may be wired, wireless, or a combination of wired and wireless. The policy administration and provisioning system 400 implements, among other things, the policy provisioning service represented by the method 100 of the FIG. 1, the policy aggregating service represented by the method 200 of the FIG. 2, and the policy publishing service represented by the method 300 of the FIG. 3.

The policy administration and provisioning system 400 includes an intermediate policy expression markup language (IPML) 401 and a policy managing service 402. In some embodiments, the policy administration and provisioning system 400 may also include one or more policy format translators 403 and/or one or more interface translators 404. Each of these will now be discussed in turn.

The IPML 401 is a defined extensible language for representing policies as rules, actions, conditions, events, and/or attributes. According to an embodiment, the IPML 401 is compatible with XML and is referred to as an extensible policy expression markup language (XPEML).

The IPML 401 is a mechanism by which disparate policies may be brought together and dynamically rendered to a plurality of disparate formats on demand. This is achieved by translating from an initial format to the IPML 401 and then from the IPML 401 to a target format. The IPML also provides the schema definitions to support the expression of the policies represented in their native formats in the IPML 401 format.

The policy managing service 402 processes and is enabled to work with the IPML 401. The policy managing service 402 translates policies to and from the IPML 401 and provisions the translated policies among heterogeneous devices.

According to an embodiment, the policy administration and provisioning system 400 may also include one or more policy format translators 403. A policy format translator 403 may be associated with a particular schema instance for a given policy format and may be called by the policy managing service 402 automatically when processing that schema to translate a policy from the IPML 401 format into the given policy format. The reverse of a given translation may also be associated with the same policy format translator 403 or with a different policy format translator 403. So, each translator 403 may permit conversion of a policy from a first format into the IPML 401 format and from the IPML 401 format back into the first format. Alternatively, a translation from a first format to the IPML 401 and then back from the IPML to the first format may be represented as two separate translators 403.

In another embodiment, the policy administration and provisioning system 400 may include one or more interface translators 404. An interface translator 404 permits a target device or resource to utilize a recognized interface to view, modify, and administer the IPML 401 formatted policies. Alternatively, the interface translator 404 may permit a target device or resource to utilize its native policy format to view, modify, and administer a policy. In this latter embodiment, the policy managing service 402 may be used to ensure the native format is rendered to the IPML 401 format for purposes of synchronization with other heterogeneous network devices or resources.

The policy managing service 402 may also be used to manage policies from PEP's. So, multiple PEP's may be combined utilizing the policy managing service 402 into a single intersection or superset of policies and then enforced through those same multiple PEP's or other designated and different PEP's.

It is now understood how policy administration and provisioning may be achieved in more efficient and portable manners. This is achieved by divorcing the policy format from the specific resource environment and utilizing an IPML 401 as an intermediary management format. Services, such as the policy managing service 402, may then synchronize policies across devices or PEP's, publish policies from one resource to another resource, and permit administration in native resource-specific formats or in the IPML 401 format. These techniques make policy definitions consistent across heterogeneous devices, resources, or PEP's; permit the expanded scope of any given policy; and expands the degree to which any given policy may be provisioned to resources over the network.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
defining a set of policies using a language for a first device and a second device, wherein the first and second devices are heterogeneous devices from one another;
translating the set of policies in a first format from the language for enforcement on first device; and
translating the set of policies in a second format from the language for enforcement on the second device.

2. The method of claim 1 further comprising:
identifying a translator for a third format associated with a third device; and
processing the translator using the set of policies in the language into the third format for enforcement on the third device.

3. The method of claim 1 further comprising, dynamically modifying the set of policies and pushing the changes from the language to the first device in the first format and the second device in the second format.

4. The method of claim 1 further comprising:
identifying modifications in the first format;
incorporating the modifications in the language; and
pushing the modifications in the second format to the second device.

5. The method of claim 1, wherein translating the set of policies in the first and second formats further includes associating the first and second formats to a policy enforcement point within an application to dynamically enforce the set of policies on the first and second device.

6. The method of claim 1, wherein translating the set of policies in the first and second formats further includes associating the first format to a first policy enforcement point within a first application to dynamically enforce the set of policies on the first device and associating the second format to a second policy enforcement point within a second application to dynamically enforce the set of policies on the second device.

7. The method of claim 1 further comprising, presenting a dynamically rendered interface to both the first and second devices for purposes of modifying and managing the set of policies in the language.

8. A method, comprising:
identifying a first policy enforcement point;
identifying a second policy enforcement point;
acquiring a first set of policies for the first policy enforcement point and a second set of policies for the second policy enforcement point;
deriving a third set of policies from the first and second set of policies;
substituting the third set of policies for the first and second policy enforcement points.

9. The method of claim 8 further comprising:
identifying the first policy enforcement point with a first application on a first device; and
identifying the second policy enforcement point, and wherein the first and second policy enforcement points have heterogeneous contexts from one another.

10. The method of claim 8 further comprising, identifying the first and second policy enforcement points within the same application, and wherein the first policy enforcement point is executed for a first device and the second policy enforcement point is executed for a second device, and wherein the first and second devices are heterogeneous devices from one another.

11. The method of claim 8, wherein deriving further includes translating the first set of policies from a first format to an intermediate format and translating the second set of policies from a second format to the intermediate format.

12. The method of claim 11 wherein substituting further includes deriving an intersection associated with the first and second policies as the third set of policies and rendering the intersection from the intermediate format to each of the first and second formats for enforcement with the first and second policy enforcement points.

13. The method of claim 8, wherein deriving further includes representing the policies as a schema having actions, conditions, and rules.

14. A method, comprising:
identifying a first set of policies associated with a first device;
translating the first set of policies to a format enforceable on a second device; and
provisioning the translated first set of policies in the format to the second device, wherein the first and second devices are heterogeneous devices from one another.

15. The method of claim 14 further comprising, acquiring the first set of policies in a first device format and translating the first device format to an intermediate format.

16. The method of claim 15 further comprising, acquiring the first set of policies in an intermediate format.

17. The method of claim 16 further comprising, augmenting the first set of policies in the intermediate format before provisioning.

18. The method of claim 14, wherein identifying further includes presenting a dynamically rendered interface on the first device to receive a publication of the first set of policies from the first device.

19. The method of claim 18, wherein provisioning further includes presenting another dynamically rendered interface on the second device to receive the installation and subsequent enforcement of the translated first set of policies on the second device.

20. A system, comprising:
an intermediate policy expression markup language; and
a policy managing service, wherein the policy managing service translates policies to and from the intermediate policy expression markup language and provisions the policies among heterogeneous devices.

21. The system of claim 20, wherein the policy managing service dynamically renders interfaces to each of the devices permitting each of the devices to assist in managing the policies.

22. The system of claim 20, wherein the policy managing service permits the policies to be selected from multiple policy enforcement points and enforced as an intersection of different policies associated with each of the policy enforcement points.

23. The system of claim 20, wherein the intermediate policy expression markup language is to represent the policies, rules, conditions, actions, and attributes associated with policy enforcement points.

24. The system of claim 23, wherein the policy enforcement points are associated with selective portions of applications that process on the heterogeneous devices.

25. The system of claim 20 further comprising, a plurality of translators, wherein each translator translates the policies from a different format into the intermediate policy expression markup language and vice versa.

26. The system of claim 20, wherein the intermediate policy expression markup language includes a schema for defining the policies and rules for accessing the policies.
